(19) United States
(12) Patent Application Publication
(10) Pub. No.: US 2026/0237542 A1
(43) Pub. Date: Aug. 13, 2026

(54) APPARATUS AND METHOD FOR IMPROVING INSULATION INTERFACE PERFORMANCE OF WRAPPED-TYPE SUBMARINE CABLE MOLDED JOINT

(71) Applicant: Tianjin University, Tianjin (CN)

(72) Inventors: Zhonglei LI, Tianjin (CN); Zhong ZHENG, Tianjin (CN); Zhaorui LUO, Tianjin (CN); Boxue DU, Tianjin (CN)

(73) Assignee: Tianjin University, Tianjin (CN)

(21) Appl. No.: 19/534,375

(22) Filed: Feb. 9, 2026

(30) Foreign Application Priority Data
Feb. 12, 2025 (CN) 202510152074.5

(51) Int. Cl. H01B 13/00; H01B 7/02; H01B 7/14; H05H 1/24

(52) U.S. Cl. CPC H01B 13/0036; H01B 7/0241; H01B 7/14; H05H 1/2406; H05H 2245/40

(57) ABSTRACT

Provided are an apparatus and a method for improving insulation interface performance of a wrapped-type submarine cable molded joint. The apparatus includes a plasma generator, a gas delivery module, and a transfer module. The plasma generator includes an upper dielectric module provided with a high-voltage electrode and a lower dielectric module provided with a grounding electrode. A plasma discharge channel is formed between the high-voltage electrode and the grounding electrode. The gas delivery module is configured in the upper dielectric module to supply an inert gas to the plasma discharge channel. The transfer module includes a discharge assembly and a receiving assembly; an insulation winding tape runs through the plasma discharge channel from the discharge assembly and is connected to the receiving assembly. The invention applies plasma discharge technology to insulation of wrapped-type submarine cable molded joints to achieve efficient, uniform, and reliable insulation restoration.

### CROSS-REFERENCE TO RELATED APPLICATION

This patent application claims the benefit and priority of Chinese Patent Application No. 202510152074.5 filed with the China National Intellectual Property Administration on Feb. 12, 2025, the disclosure of which is incorporated by reference herein in its entirety as part of the present application

### TECHNICAL FIELD

The present disclosure relates to the field of high-voltage direct-current cable insulation technologies, and in particular to an apparatus and a method for improving insulation interface performance of a wrapped-type submarine cable molded joint.

### BACKGROUND

High-voltage direct-current submarine cables (hereinafter referred to as “high-voltage direct-current (HDVC) submarine cables”) serve as an important link for power grid interconnection and a “main artery” for clean energy transmission, and their importance is becoming increasingly prominent. By virtue of their unique advantages of long distance, large capacity, and low loss transmission, the high-voltage direct-current submarine cables have become key infrastructures for building new power systems and promoting green transformation of energy sources. Large-length high-voltage direct-current submarine cables constitute the key technical support for the grid-connected power generation of clean energy sources such as offshore wind power.

In a high-voltage direct-current submarine cable system, a submarine cable molded joint serves as a core component for realizing the flexible continuation of multiple submarine cable sections. Insulation performance of the submarine cable molded joint directly affects stability and security of a whole power transmission system. A wrapped-type submarine cable molded joint is typically formed by a wrapping process in which, after conductor connection, recovery insulation tapes are wrapped layer by layer around the conductor, followed by melt molding through synchronous heating of the conductor and a heating hood, thereby restoring the insulation. However, during the fusion restoration process, pronounced space charge accumulation often occurs in homogeneous insulation interfacial regions between adjacent winding tape layers due to factors such as surface roughness, fusion defects, and crystallization mismatches. This causes electric field distortion within the insulation, thereby triggering partial discharge and accelerating insulation degradation or even leading to breakdown failure, which seriously threatens the insulation performance of the submarine cable molded joint and the safe and stable operation of the power transmission system.

Therefore, there is an urgent need to improve the insulation performance of the interfacial regions in wrapped-type direct-current submarine cable molded joints. Existing methods for suppressing interfacial charge accumulation and improving insulation performance mainly include ZnO spraying and sandpaper polishing. Although these methods can improve insulation restoration quality to some extent, there are obvious limitations. The ZnO spraying method suffers from problems such as low treatment efficiency, large consumption of materials, poor treatment uniformity, and possible generation of decomposition by-products, thereby limiting wide application in practical engineering. The sandpaper polishing method is limited by skills of workers on site. Force and directions during polishing are difficult to control, which easily causes damage to the winding tape, and the consistency of the polishing effect is hard to guarantee, making it difficult to meet requirements of large-scale industrial production.

In view of the deficiencies of the aforementioned prior art, there is an urgent need for a novel method for improving insulation interface performance of a wrapped-type direct-current submarine cable molded joint.

### SUMMARY

An objective of the present disclosure is to provide an apparatus and a method for improving insulation interface performance of a wrapped-type submarine cable molded joint, so as to solve the foregoing problems existing in the prior art. The present disclosure can effectively suppress interfacial charge accumulation in a submarine cable molded joint, thereby improving insulation performance, and enhancing breakdown field strength. In addition, the present disclosure overcomes the limitations of the prior art by applying plasma discharge technology to the insulation of full-size wrapped-type submarine cable molded joints, so as to achieve efficient, uniform, and reliable insulation restoration.

In order to achieve the foregoing objective, the present disclosure provides the following solutions.

The present disclosure provides an apparatus for improving insulation interface performance of a wrapped-type submarine cable molded joint, including a plasma generator, a gas delivery module, and a transfer module. The plasma generator includes an upper dielectric module and a lower dielectric module, the upper dielectric module is provided with a high-voltage electrode, the lower dielectric module is provided with a grounding electrode, and a plasma discharge channel is formed between the high-voltage electrode and the grounding electrode; the gas delivery module is configured to charge an inert gas to the plasma discharge channel; and the transfer module includes a discharge assembly and a receiving assembly, and an insulation winding tape runs through the plasma discharge channel from the discharge assembly and is connected to the receiving assembly.

In an embodiment, the apparatus further includes an insulation fixed plate and a lifting assembly. The upper dielectric module is mounted on the insulation fixed plate by means of the lifting assembly, and the lifting assembly is configured to drive the upper dielectric module to perform a lifting movement.

In an embodiment, a hollow slot is formed in the upper dielectric module, a movable end of the lifting assembly is mounted on a top inside the hollow slot, the high-voltage electrode is mounted at a bottom inside the hollow slot, and the grounding electrode is mounted at a bottom of the lower dielectric module.

In an embodiment, the upper dielectric module is provided with an embedded gas channel, the embedded gas channel extends along the upper dielectric module in the hollow slot, a gas inlet is formed in a top of the upper dielectric module, a gas outlet is formed in a bottom of the upper dielectric module, and the gas outlet faces the plasma discharge channel.

In an embodiment, the gas delivery module includes a gas cylinder and a flowmeter, the gas cylinder stores the inert gas, the gas cylinder is connected to the gas inlet by means of a gas pipe, the flowmeter is disposed on the gas pipe, and the flowmeter is configured to control a flow of the inert gas.

In an embodiment, the discharge assembly includes an unwinding roller and a first constraint roller; the receiving assembly includes a take-up roller and a second constraint roller; an untreated insulation winding tape is located in the unwinding roller, a treated insulation winding tape is located in the take-up roller, and the insulation winding tape from the unwinding roller passes through the first constraint roller, the plasma discharge channel, and the second constraint roller in sequence to reach the take-up roller.

In an embodiment, the unwinding roller, the first constraint roller, the second constraint roller, and the take-up roller are connected to independent drive motors, and the drive motors are mounted on the insulation fixed plate.

The present disclosure further provides a method for improving insulation interface performance of a wrapped-type submarine cable molded joint, using the apparatus for improving insulation interface performance of a wrapped-type submarine cable molded joint recorded in the previous text, and the method including:
S1: placing an untreated insulation winding tape on the discharge assembly, and pulling out a certain length of the insulation winding tape passing through the plasma discharge channel to the receiving assembly, so as to complete a constraint on a movement path of the insulation winding tape;
S2: adjusting a spacing between the upper dielectric module and the lower dielectric module to meet a set requirement, and turning on the high-voltage electrode and the gas delivery module, so as to generate plasma in the plasma discharge channel;
S3: starting a transfer assembly, releasing the insulation winding tape by using the discharge assembly, and taking up the insulation winding tape by using the receiving assembly; and
S4: after treatment is complete, taking down the treated insulation winding tape.

In an embodiment, a constraint on the insulation winding tape is formed by using a first constraint roller in the discharge assembly and a second constraint roller in the receiving assembly, so that the insulation winding tape is kept to move in a set track.

In an embodiment, the method further includes the following steps:
S5: welding a cable conductor, wrapping a conductor shielding layer, and wiping a surface of body insulation;
S6: removing untreated parts of the insulation winding tape at a front end and a back end of the insulation winding tape, and winding the treated insulation winding tape around a surface of the conductor shielding layer turn by turn until a defective insulation area is filled; and
S7: fusing the insulation winding tape wound turn by turn into a whole, so as to complete insulation restoration.

Compared with the prior art, the present disclosure achieves the following technical effects.

In the present disclosure, the insulation winding tape is treated by using the plasma generator in an atmosphere of an inert gas, and active particles generated by atmospheric pressure discharge plasma can be applied to a surface of the insulation winding tape, so as to effectively suppress interfacial charge accumulation in a submarine cable molded joint, thereby improving insulation performance, and enhancing breakdown field strength. In addition, the transfer module is configured to implement discharge and receiving of the insulation winding tape, and limitations in the prior art can be overcome. The plasma discharge technology can be applied to insulation of full-size wrapped-type submarine cable molded joints, so as to improve insulation performance of the wrapped-type submarine cable molded joint, implement efficient, uniform, and reliable insulation restoration, and provide strong technical support for promoting improvement on independent innovation capability of high-end power equipment, supporting large-scale offshore wind power, and ensuring safe and stable operation of power.

### BRIEF DESCRIPTION OF THE DRAWINGS

To more clearly illustrate embodiments of the present disclosure or technical solutions in the prior art, the following briefly introduces the accompanying drawings to be used in the embodiments. Apparently, the accompanying drawings in the following description show merely some embodiments of the present disclosure, and those skilled in the art can still derive other accompanying drawings from these drawings without creative efforts.

FIG. 1 is a front view of an apparatus for improving insulation interface performance of a wrapped-type submarine cable molded joint according to an embodiment of the present disclosure;

FIG. 2 is a top view of an apparatus for improving insulation interface performance of a wrapped-type submarine cable molded joint according to an embodiment of the present disclosure;

FIG. 3 is a side view of an apparatus for improving insulation interface performance of a wrapped-type submarine cable molded joint according to an embodiment of the present disclosure;

FIG. 4 is a schematic diagram of a preparation process for insulation of a wrapped-type direct-current submarine cable molded joint according to an embodiment of the present disclosure;

FIG. 5 is a schematic diagram of cutting a double-layer interlayer interface plate sample according to an embodiment of the present disclosure;

FIG. 6 shows discharge images of a dielectric barrier discharge plasma reactor under different voltage amplitudes, frequencies, and gas flow rates according to an embodiment of the present disclosure;

FIG. 7 is a flow chart of a method for improving insulation interface performance of a wrapped-type submarine cable molded joint according to an embodiment of the present disclosure;

FIG. 8 shows micro-morphology images of sample interfaces in a comparative example and an embodiment of the present disclosure;

FIG. 9 shows distribution situations of charges on both sides of an interlayer interface during polarization under a high field of 40 kV/mm for 1800 s in a comparative example and an embodiment of the present disclosure;

FIG. 10 shows a DCIC-Q(t) curve chart of current integrated charge of samples in a comparative example and an embodiment of the present disclosure; and

FIG. 11 shows a Weibull distribution graph of an interface normal breakdown field strength of samples in a comparative example and an embodiment of the present disclosure.

Reference numerals in the figures: 1—insulation fixed plate; 2—insulation winding tape; 3—lifting assembly; 4—embedded gas channel; 5—gas inlet; 6: gas outlet; 7—hollow slot; 8—high-voltage electrode; 9—grounding electrode; 10—nanosecond-pulse excitation power supply; 11—upper dielectric module; 12—lower dielectric module; 13—gas cylinder; 14—flowmeter; 15—take-up roller; 16—unwinding roller; 17—second constraint roller; 18—limit slot; 19—first constraint roller; 20—cable conductor; 21—conductor shielding layer; 22—body insulation; 23—soft mold; 24—uniform-temperature aluminum film; 25—high temperature resistant polyimide tape; 26—heating tape; 27—motor; 28—sliding rail; and 29—plate sample.

### DETAILED DESCRIPTION OF THE EMBODIMENTS

The following clearly and completely describes technical solutions in embodiments of the present disclosure with reference to drawings in the embodiments of the present disclosure. Apparently, the described embodiments are merely a part rather than all of the embodiments of the present disclosure. All other embodiments obtained by those skilled in the art on the basis of the embodiments of the present disclosure without requiring the exercise of inventive effort fall within the scope of protection of the present disclosure.

An objective of the present disclosure is to provide an apparatus and a method for improving insulation interface performance of a wrapped-type submarine cable molded joint, so as to solve problems existing in the prior art. The present disclosure can effectively suppress interfacial charge accumulation in a submarine cable molded joint, thereby improving insulation performance, enhancing breakdown field strength, and overcoming limitations in the prior art. A plasma discharge technology can be applied to insulation of full-size wrapped-type submarine cable molded joints, so as to improve insulation performance of the wrapped-type submarine cable molded joint and implement efficient, uniform, and reliable insulation restoration.

To make the foregoing objectives, features and advantages of the present disclosure clearer and more comprehensible, the present disclosure is further described in detail below with reference to the drawings and the specific implementations.

In the present disclosure, by using the apparatus for improving insulation interface performance of a wrapped-type submarine cable molded joint, a dielectric barrier discharge plasma reaction system is established, and key parameters for operation of the dielectric barrier discharge plasma system and a moving speed of the transfer apparatus are determined. The technology can suppress a charge accumulation problem of an interface between insulation layers to a greater degree, and enhance breakdown field strength. Specifically, the active particles generated by atmospheric pressure discharge plasma are applied to the surface of the insulation winding tape, and the technology can implement optimization of a micromorphology on the surface of the insulation winding tape, so that fusion quality between insulation layers is greatly improved. Therefore, a problem that a large quantity of space charges are accumulated under direct-current stress due to structural defects of the interlayer interface is suppressed, thereby improving breakdown field strength.

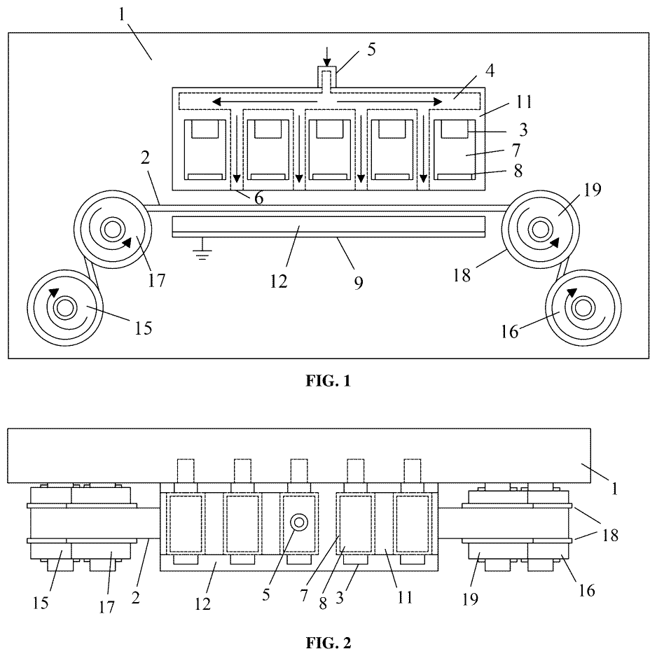

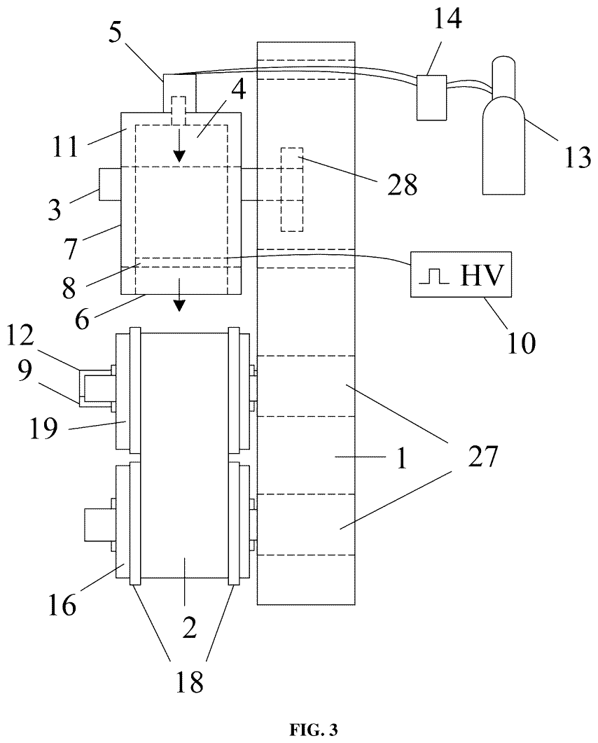

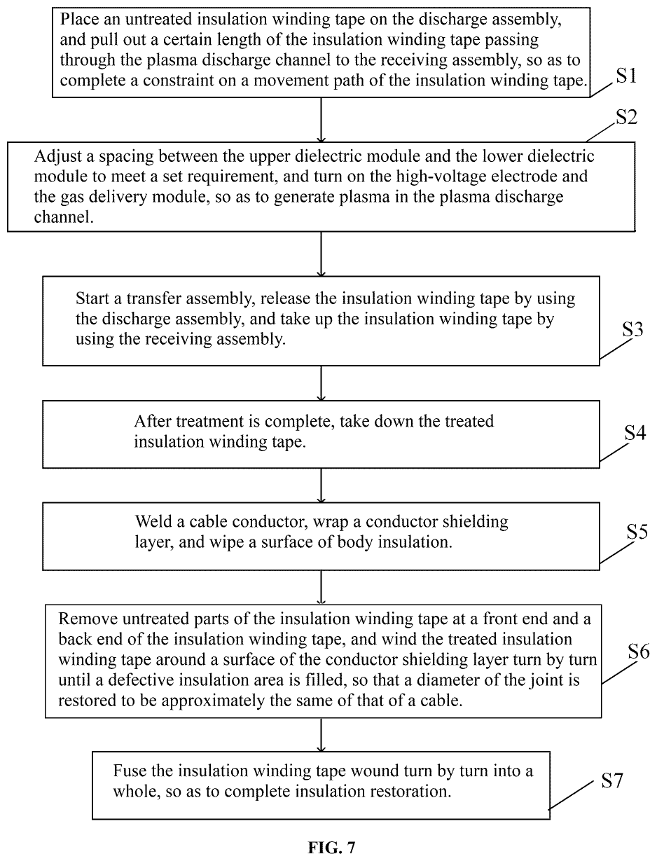

As shown in FIG. 1 to FIG. 11, the present disclosure provides an apparatus for improving insulation interface performance of a wrapped-type submarine cable molded joint, which is mainly applied to a wrapped-type submarine cable molded joint, and also can be applied to a ground-use wrapped-type cable joint. The apparatus for improving insulation interface performance of a wrapped-type submarine cable molded joint includes a plasma generator, a gas delivery module, and a transfer module, where the plasma generator includes an upper dielectric module 11 and a lower dielectric module 12, the upper dielectric module 11 is provided with a high-voltage electrode 8, the high-voltage electrode 8 is connected to a nanosecond-pulse excitation power supply 10, the lower dielectric module is 12 is provided with a grounding electrode 9, the grounding electrode 9 is grounded, and a plasma discharge channel is formed between the high-voltage electrode 8 and the grounding electrode 9. In the plasma discharge channel, discharge is performed under the effect of the high-voltage electrode 8 and the grounding electrode 9, so as to generate a high voltage and generate plasma through high-voltage discharge. The high-voltage electrode 8 and the grounding electrode 9 may both be made of copper foil materials, and have better conductivity. It should be noted that, to form the dielectric barrier discharge, barrier dielectrics are respectively disposed between the high-voltage electrode 8 and the plasma discharge channel, and between the low-voltage electrode 9 and the plasma discharge channel. The barrier dielectrics may be the upper dielectric module 11 and the lower dielectric module 12. The gas delivery module is configured to inflate an inert gas into the plasma discharge channel, so that the surface treatment of the insulation winding tape 2 can be performed in an atmosphere of the inert gas. The transfer module includes a discharge assembly and a receiving assembly. The discharge assembly is configured to store a to-be-treated insulation winding tape 2 (made of materials such as polypropylene, polyethylene, and crosslinked polyethylene, etc.). The receiving assembly is configured to receive treated insulation winding tape 2. Therefore, the insulation winding tape 2 runs through the plasma discharge channel from the discharge assembly and is connected to the receiving assembly to form a continuous treatment process. In addition, the treatment effect can be adjusted by controlling receiving and discharge speeds of the discharge assembly and the receiving assembly.

In the present disclosure, the insulation winding tape 2 is treated by using the plasma generator in an atmosphere of an inert gas, and active particles generated by atmospheric pressure discharge plasma can be applied to a surface of the insulation winding tape 2, so as to effectively suppress interfacial charge accumulation in a submarine cable molded joint, thereby improving insulation performance, and enhancing breakdown field strength. In addition, the transfer module is configured to implement discharge and receiving of the insulation winding tape 2, and limitations in the prior art can be overcome. The plasma discharge technology can be applied to insulation of full-size wrapped-type submarine cable molded joints, so as to improve insulation performance of the wrapped-type submarine cable molded joint, implement efficient, uniform, and reliable insulation restoration, and provide strong technical support for promoting improvement on independent innovation capability of high-end power equipment, supporting large-scale offshore wind power, and ensuring safe and stable operation of power.

After the insulation winding tape 2 is treated by using the foregoing apparatus for improving insulation interface performance of a wrapped-type submarine cable molded joint, the insulation winding tape 2 may be applied to submarine cable connection. During specific implementation, first, a cable conductor 20 at one end of two adjacent submarine cables is welded, and a conductor shielding layer 21 is wrapped, and then several turns of the insulation winding tape 2 are wound around the original insulation surface at the joint, so as to fill an insulation gap and restore it to a diameter of the original cable. Finally, the multiple layers of insulation winding tape 2 are fused under simultaneous heating of a heating hood and the cable conductor 20, so as to form an insulator. The insulator is used as a restoration insulator. Compared with the prior art, the insulation performance can be significantly, and efficient, uniform, and reliable insulation restoration can be implemented.

In an embodiment, the apparatus further includes a support apparatus. The support apparatus may be of a support structure such as a support frame and a support plate. In the embodiment, an insulation fixed plate 1 is used. The insulation fixed plate 1 is configured to support an upper dielectric module 11. In addition, a hole is further formed in the insulation fixed plate 1, so as to respectively connect an electric wire and a gas pipe to a nanosecond-pulse excitation power supply 10 and a gas cylinder 13. The apparatus further includes a lifting assembly 3. The upper dielectric module 11 is mounted on the insulation fixed plate 1 by using the lifting assembly 3. The lifting assembly 3 may include a sliding rail 28 disposed on the insulation fixed plate 1. One end of the support rod is slidably connected to the sliding rail 28, and the other end of the support rod is connected to the upper dielectric module 11. The upper dielectric module 11 can be driven to perform a lifting movement by using the lifting assembly 3. A spacing between the upper dielectric module 11 and the lower dielectric module 12 may be changed by means of the lifting movement of the upper dielectric module 11, and a discharge spacing is adjusted, so as to adjust the treatment effect on the insulation winding tape 2.

In an embodiment, hollow slots 7 are formed in the upper dielectric module 11. The number of the hollow slots 7 is set as required. At least one hollow slot is disposed. Two or more than two, such as five, hollow slots may be set. The hollow slot 7 runs through the upper dielectric module 11 along a horizontal direction, and a movable end (for example, the aforementioned support rod) of the lifting assembly 3 is mounted on a top inside the hollow slot 7, so as to implement lifting movement of the upper dielectric module 11. The number of the support rods may be in a one-to-one correspondence with the number of the hollow slots 7. The support rods can be disposed only in the hollow slots 7 near an end inside the upper dielectric module 11. The high-voltage electrode 8 is mounted at a bottom of the hollow slot 7. The number may be in a one-to-one correspondence with the number of the hollow slots 7, and the upper dielectric module 11 is used as a barrier dielectric for discharge. The grounding electrode 9 is mounted at a bottom of the lower dielectric module 12. The lower dielectric module 12 is used as a barrier dielectric for discharge.

In an embodiment, the barrier dielectric of the upper dielectric module 11 is a three-dimensionally printed resin material with a thickness of 0.1 cm to 10 cm (preferably 0.2 cm), and the barrier dielectric of the lower dielectric module 12 is a quartz glass material with a thickness of 0.1 cm to 1.0 cm (preferably 0.2 cm). Both as barrier dielectrics for discharge. The upper dielectric module 11 and the lower dielectric module 12 have a spacing of 0.5 cm to 2 cm (preferably 1 cm). Both the high-voltage electrode 8 and the grounding electrode 9 are adhesive electrodes with a thickness of 1 mm to 3 mm (preferably 2 mm).

In an embodiment, the upper dielectric module 11 is provided with an embedded gas channel 4. The embedded gas channel 4 extends along the upper dielectric module 11 between the hollow slots 7, so as to form a path in which gas flows from up to down. A gas inlet 5 is formed in a top of the upper dielectric module 11, and a gas outlet 6 is formed in a bottom of the upper dielectric module 11. Only one gas inlet 5 may be disposed, and a plurality of gas outlets 6 may be uniformly disposed based on a length of the plasma discharge channel. In addition, the gas outlet 6 faces the plasma discharge channel, and releases an inert gas through the gas outlet 6 to form an inert gas atmosphere.

In an embodiment, the gas delivery module includes a gas cylinder 13 and a flowmeter 14. The gas cylinder 13 stores an inert gas, and the inert gas may be argon, helium, nitrogen, or the like. The gas cylinder 13 is connected to the gas inlet 5 by using the gas pipe, and the gas inlet 5 may lead to the gas outlet 6 by using the embedded gas channel 4 recorded in the previous text. Certainly, other flow paths (for example, a pipeline independent of the upper dielectric module 11) may be disposed. The flowmeter 14 is disposed on the gas pipe, and the flowmeter 14 has functions of monitoring and controlling the flow rate. The flow rate of the inert gas can be controlled by using the flowmeter 14.

In an embodiment, the discharge assembly includes an unwinding roller 16 and a first constraint roller 19, and the receiving assembly includes a take-up roller 15 and a second constraint roller 17. The untreated insulation winding tape 2 is located in the unwinding roller 16, and the treated insulation winding tape 2 is located in the take-up roller 15. The insulation winding tape 2 passes through the first constraint roller 19, the plasma discharge channel, and the second constraint roller 17 in sequence to reach the take-up roller 15 from the unwinding roller 16. The unwinding roller 16 is configured to unwind the untreated insulation winding tape 2, and the take-up roller 15 is configured to take up and roll up the treated insulation winding tape 2. The unwinding roller 16 and the take-up roller 15 may cooperate with each other to preferably treat a large-area and large-length insulation winding tape 2, so as to reach a truly implementable level in engineering. The first constraint roller 19 and the second constraint roller 17 cooperate with each other to restrict the insulation winding tape 2, so as to straighten the moving insulation winding tape 2, so that the insulation winding tape 2 stably passes through the plasma discharge channel.

In an embodiment, the unwinding roller 16, the first constraint roller 19, the second constraint roller 17, and the take-up roller are 15 all connected to independent drive motors 27. A rotational speed of any roller may be adjusted by controlling the different drive motors 27. The take-up roller 15 and the unwinding roller 16 are located at lower parts of both ends of the lower dielectric module 12. The first constraint roller 19 and the second constraint roller 17 are located above the take-up roller 15 and the unwinding roller 16, and are integrally formed in an inverted U-shaped shape. The drive motor 27 is mounted on the insulation fixed plate 1, so as to support each roller by using the insulation fixed plate 1 and determine relative positions among the different rollers.

In an embodiment, diameters of the take-up roller 15, the unwinding roller 16, the first constraint roller 19, and the second constraint roller 17 are all the same, and are respectively 3 cm to 7 cm, preferably 5 cm. A limit slot 18 is respectively formed in each roller, so as to mount the insulation winding tape 2 and restrict a movement track of the insulation winding tape 2.

Referring to FIG. 1 to FIG. 11 again, the present disclosure further provides a method for improving insulation interface performance of a wrapped-type submarine cable molded joint, using the apparatus for improving insulation interface performance of a wrapped-type submarine cable molded joint recorded in the previous text, and the method including:
S1: An untreated insulation winding tape 2 is placed on a discharge assembly, and a certain length of the insulation winding tape 2 is pulled out and passes through a plasma discharge channel to the receiving assembly, so as to complete a constraint on a movement path of the insulation winding tape 2.
S2: A spacing between an upper dielectric module 11 and a lower dielectric module 12 is adjusted to meet a set requirement (for example, 0.5 cm to 2 cm) by adjusting a lifting assembly 3, a nanosecond-pulse excitation power supply 10 connected to a high-voltage electrode 8 is turned on, and a gas delivery module is turned on, so as to generate plasma in the plasma discharge channel. When the nanosecond-pulse excitation power supply 10 has a voltage amplitude in the range of 7 kV to 15 kV, a frequency in the range of 1 kHz to 7 kHz, a pulse width in the range of 500 ns to 2000 ns, a rise time and a fall time in the range of 50 ns to 150 ns, and an argon gas flow rate in the range of 500 mL/min to 5000 mL/min, plasma with moderate intensity, good uniformity, and favorable plume length and morphology can be generated.

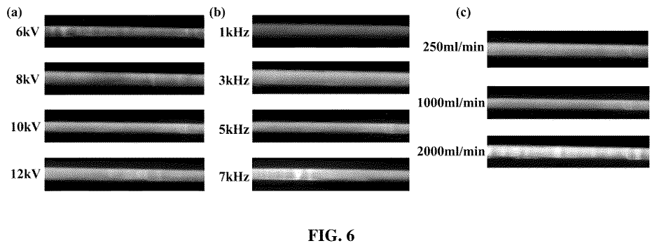

In an embodiment, parameters of a dielectric barrier discharge plasma reaction system and the gas flow rate are determined, as shown in FIG. 6. In a further embodiment, the nanosecond-pulse excitation power supply 10 has a voltage amplitude of 10 kV, a frequency of 7 kHz, a pulse width of 800 ns, a rise time and a fall time in the range of 100 ns, and an argon gas flow rate of 1500 mL/min. In a further embodiment, the distance between the upper dielectric module 11 and the lower dielectric module 12 is 1 cm.
S3: A transfer assembly is started, the insulation winding tape 2 is released by using the discharge assembly, and the insulation winding tape 2 is taken up by using the receiving assembly.

In an embodiment, the take-up roller 15 and the unwinding roller 16 are disposed to rotate clockwise, and the first constraint roller 19 and the second constraint roller 17 are disposed to rotate counterclockwise, with the same and constant rotational speed. A rotational speed of a transfer apparatus is determined. In a further embodiment, the take-up roller 15 and the unwinding roller 16 rotate clockwise, with a rotational speed in the range of 3 r/min to 6 r/min, preferably 4 r/min. The first constraint roller 19 and the second constraint roller 17 rotate counterclockwise, with a rotational speed in the range of 3 r/min to 6 r/min, preferably 4 r/min.
S4: After treatment is complete, the nanosecond-pulse excitation power supply 10, the gas delivery module, and the transfer module are turned off, and the treated insulation winding tape 2 is taken down.

In an embodiment, a constraint on the insulation winding tape 2 is formed by using the first constraint roller 19 in the discharge assembly and the second constraint roller 17 in the receiving assembly, so that the insulation winding tape 2 is kept to move in a set track. In an embodiment, the method further includes the following steps:
S5: A cable conductor 20 is welded, a conductor shielding layer 21 is wrapped, and a surface of body insulation 22 with materials such as clean alcohol test paper is wiped.
S6: Untreated parts of the insulation winding tape 2 at a front end and a back end are removed, and the treated insulation winding tape 2 is wound around a surface of the conductor shielding layer 21 and the body insulation 22 turn by turn until an insulating vacant part area is filled, so that a diameter of the joint is restored to be approximately the same of that of the cable.
S7: The insulation winding tape 2 wound turn by turn is fused into a whole, so as to complete insulation restoration.

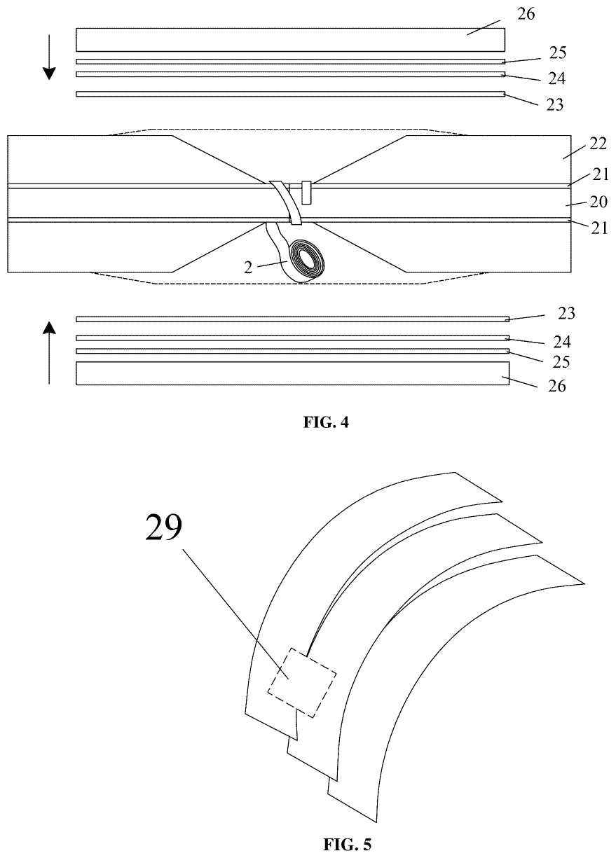

In an embodiment, as shown in FIG. 4, in step S7, a soft mold 23 for shaping and pressure maintaining, a uniform-temperature aluminum film 24, and a high temperature resistant polyimide tape 25 are successively mounted (wound around at least one circle), and a heating tape 26 is wound on an outer-diameter side of the high temperature resistant polyimide tape 25, and the insulation winding tape 2 is fused into an integral whole in a manner of synchronous heating with the cable conductor 20.

The present disclosure provides experimental verification:

For the wrapped-type submarine cable molded joint that is completed by using the foregoing method for improving insulation interface performance of a wrapped-type submarine cable molded joint, a special cutter is used to cut a sample between insulation restoration layers (as shown in FIG. 5), so as to obtain a blocky double-layer interlayer plate sample 29.

A treatment effect is verified by setting a comparative example. The comparative example is the double-layer interlayer plate sample 29 untreated by the apparatus and the method in the present disclosure, that is, a submarine cable molded joint insulation analog sample prepared by using the untreated insulation winding tape 2.

An interface micro-morphology is observed by a scanning electron microscope (SEM), which can characterize the fusion quality of an insulation interface of the submarine cable molded joint. FIG. 8 is micro-morphology images of interfaces in a comparative example and an embodiment. In the comparative example, sizes and ranges of micro-crack air gap defects on the interface are large. In the embodiment, the sizes and ranges of the micro-crack air gap defects on the interface are reduced, and interface restoration quality is significantly improved.

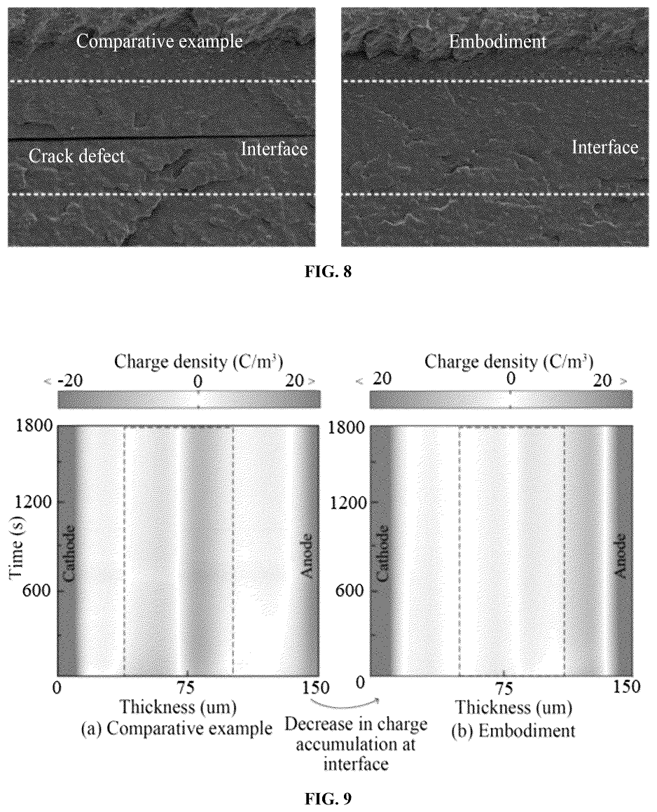

By means of a pulsed electro-acoustic space charge (PEA) measurement technology, space charge distribution at the interface between the insulation restoration layers of the submarine cable molded joint is characterized. The charge density near the interface between the layers reflects an accumulation situation of charges at the interface of the samples. FIG. 9 is distribution situations of charges on both sides of an interface between insulation restoration layers during polarization under a high field of 40 kV/mm for 1800 s in a comparative example and an embodiment. In the comparative example, there are obvious heteropolar charges accumulated near the interface. In the embodiment, after plasma treatment, an accumulation phenomenon of interface charges is significantly alleviated.

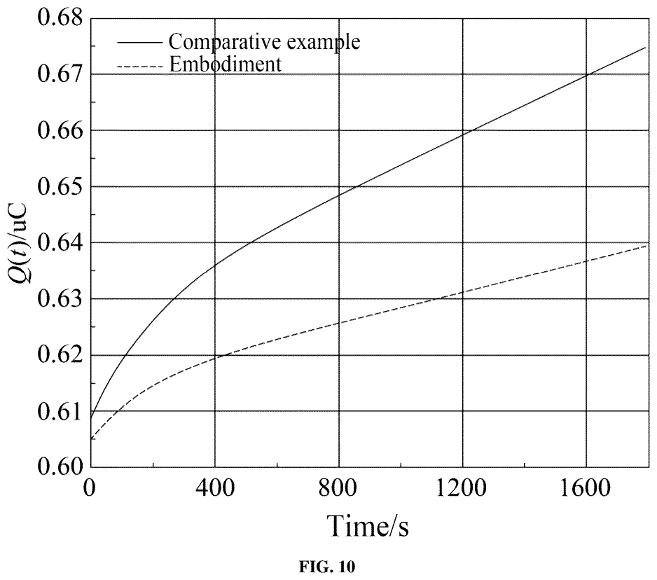

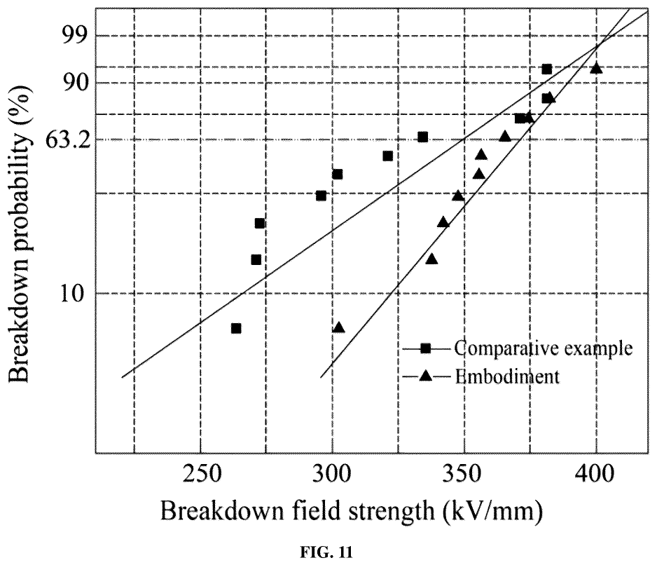

The accumulation phenomenon of space charges at the interface between the insulation restoration layers is quantified by using a current integration technology, and the magnitude of a conductive current is calculated and obtained. Collected data is fitted by using the following formula, so as to obtain curves of current integrated charges DCIC-Q(t) of samples in a comparative example and an embodiment as shown in FIG. 10.

$$Q ( t ) = Q ( 0 ) + {Q}_{s p a c e} ( 1 - exp ( - \frac{t}{τ} ) ) + {I}_{c o n d} t$$

In the formula, Q(t) is integral total charge quantity, with a unit of Coulomb (C); Q(0) is initial charge quantity, with a unit of C, related to a sample attribute; Q_{space} is a space charge, with a unit of C, indicating a space charge accumulation component in the sample; I_{cond} is a conduction current, with a unit of ampere (A), indicating a current component formed by carrier migration in the sample; t is time, with a unit of second(s); and τ is a time constant.

It can be seen from the curves that, in the comparative example, Q(0)=0.61, Q_{space}=0.019, τ=204.60, and I_{cond}=2.61. However, in the embodiment, all the four parameters are reduced, Q(0)=0.60, Q_{space}=0.009, τ=161.60, I_{cond}=1.39, so that a charge migration rate is decreased, and charge accumulation is obviously suppressed.

By measuring the normal breakdown field strength of the sample interface, the electrical insulation strength of the interface between the insulation layers of the submarine cable molded joint is characterized. FIG. 11 shows Weibull distribution graphs of an interface normal breakdown field strength of samples in a comparative example and an embodiment. In the comparative example, the normal breakdown field strength of the interface is 348.85 kV/mm. In the embodiment, the breakdown field strength is increased to 367.99 kV/mm, and the electrical insulation strength is significantly improved.

Specific examples are used for illustration of the principles and implementations of the present disclosure. The description of the above-mentioned embodiments is used to help illustrate the method and core principles of the present disclosure. In addition, those skilled in the art can make various modifications in terms of specific implementations and scope of application in accordance with the teachings of the present disclosure. In summary, the contents of this specification should not be understood as the limitation of the present disclosure.

1. An apparatus for improving insulation interface performance of a wrapped-type submarine cable molded joint, wherein the apparatus comprises:
a plasma generator, wherein the plasma generator comprises an upper dielectric module and a lower dielectric module, the upper dielectric module is provided with a high-voltage electrode, the lower dielectric module is provided with a grounding electrode, and a plasma discharge channel is formed between the high-voltage electrode and the grounding electrode;
a gas delivery module, wherein the gas delivery module is configured to charge an inert gas to the plasma discharge channel;
a transfer module, wherein the transfer module comprises a discharge assembly and a receiving assembly, and an insulation winding tape runs through the plasma discharge channel from the discharge assembly and is connected to the receiving assembly; and
an insulation fixed plate and a lifting assembly, wherein the upper dielectric module is mounted on the insulation fixed plate by means of the lifting assembly, and the lifting assembly is configured to drive the upper dielectric module to perform a lifting movement;
wherein a hollow slot is formed in the upper dielectric module, a movable end of the lifting assembly is mounted on a top inside the hollow slot, the high-voltage electrode is mounted at a bottom inside the hollow slot, and the grounding electrode is mounted at a bottom of the lower dielectric module;
wherein the upper dielectric module is provided with an embedded gas channel, the embedded gas channel extends along the upper dielectric module between the hollow slots, a gas inlet is formed in a top of the upper dielectric module, a gas outlet is formed in a bottom of the upper dielectric module, and the gas outlet faces the plasma discharge channel.

2. The apparatus for improving insulation interface performance of a wrapped-type submarine cable molded joint according to claim 1, wherein the gas delivery module comprises a gas cylinder and a flowmeter, the gas cylinder stores the inert gas, the gas cylinder is connected to the gas inlet by means of a gas pipe, the flowmeter is disposed on the gas pipe, and the flowmeter is configured to control a flow of the inert gas.

3. The apparatus for improving insulation interface performance of a wrapped-type submarine cable molded joint according to claim 1, wherein the discharge assembly comprises an unwinding roller and a first constraint roller; the receiving assembly comprises a take-up roller and a second constraint roller; an untreated insulation winding tape is located in the unwinding roller, a treated insulation winding tape is located in the take-up roller, and the insulation winding tape from the unwinding roller passes through the first constraint roller, the plasma discharge channel, and the second constraint roller in sequence to reach the take-up roller.

4. The apparatus for improving insulation interface performance of a wrapped-type submarine cable molded joint according to claim 3, wherein the unwinding roller, the first constraint roller, the second constraint roller, and the take-up roller are connected to independent drive motors, and the drive motors are mounted on the insulation fixed plate.

5. A method for improving insulation interface performance of a wrapped-type submarine cable molded joint, using the apparatus for improving insulation interface performance of a wrapped-type submarine cable molded joint according to claim 1, and the method comprising:
S1: placing an untreated insulation winding tape on the discharge assembly, and pulling out a certain length of the insulation winding tape passing through the plasma discharge channel to the receiving assembly, so as to complete a constraint on a movement path of the insulation winding tape;
S2: adjusting a spacing between the upper dielectric module and the lower dielectric module to meet a set requirement, and turning on the high-voltage electrode and the gas delivery module, so as to generate plasma in the plasma discharge channel;
S3: starting a transfer assembly, releasing the insulation winding tape by using the discharge assembly, and taking up the insulation winding tape by using the receiving assembly; and
S4: after treatment is complete, taking down the treated insulation winding tape.

6. The method for improving insulation interface performance of a wrapped-type submarine cable molded joint according to claim 5, wherein a constraint on the insulation winding tape is formed by using a first constraint roller in the discharge assembly and a second constraint roller in the receiving assembly, so that the insulation winding tape is kept to move in a set track.

7. The method for improving insulation interface performance of a wrapped-type submarine cable molded joint according to claim 5, further comprising the following steps:
S5: welding a cable conductor, wrapping a conductor shielding layer, and wiping a surface of body insulation;
S6: removing untreated parts of the insulation winding tape at a front end and a back end of the insulation winding tape, and winding the treated insulation winding tape around a surface of the conductor shielding layer turn by turn until a defective insulation area is filled; and
S7: fusing the insulation winding tape wound turn by turn into a whole, so as to complete insulation restoration.

8. The method for improving insulation interface performance of a wrapped-type submarine cable molded joint according to claim 5, wherein the gas delivery module comprises a gas cylinder and a flowmeter, the gas cylinder stores the inert gas, the gas cylinder is connected to the gas inlet by means of a gas pipe, the flowmeter is disposed on the gas pipe, and the flowmeter is configured to control a flow of the inert gas.

9. The method for improving insulation interface performance of a wrapped-type submarine cable molded joint according to claim 8, wherein a constraint on the insulation winding tape is formed by using a first constraint roller in the discharge assembly and a second constraint roller in the receiving assembly, so that the insulation winding tape is kept to move in a set track.

10. The method for improving insulation interface performance of a wrapped-type submarine cable molded joint according to claim 8, further comprising the following steps:
S5: welding a cable conductor, wrapping a conductor shielding layer, and wiping a surface of body insulation;
S6: removing untreated parts of the insulation winding tape at a front end and a back end of the insulation winding tape, and winding the treated insulation winding tape around a surface of the conductor shielding layer turn by turn until a defective insulation area is filled; and
S7: fusing the insulation winding tape wound turn by turn into a whole, so as to complete insulation restoration.

11. The method for improving insulation interface performance of a wrapped-type submarine cable molded joint according to claim 5, wherein the discharge assembly comprises an unwinding roller and a first constraint roller; the receiving assembly comprises a take-up roller and a second constraint roller; an untreated insulation winding tape is located in the unwinding roller, a treated insulation winding tape is located in the take-up roller, and the insulation winding tape from the unwinding roller passes through the first constraint roller, the plasma discharge channel, and the second constraint roller in sequence to reach the take-up roller.

12. The method for improving insulation interface performance of a wrapped-type submarine cable molded joint according to claim 11, wherein a constraint on the insulation winding tape is formed by using a first constraint roller in the discharge assembly and a second constraint roller in the receiving assembly, so that the insulation winding tape is kept to move in a set track.

13. The method for improving insulation interface performance of a wrapped-type submarine cable molded joint according to claim 11, further comprising the following steps:
S5: welding a cable conductor, wrapping a conductor shielding layer, and wiping a surface of body insulation;
S6: removing untreated parts of the insulation winding tape at a front end and a back end of the insulation winding tape, and winding the treated insulation winding tape around a surface of the conductor shielding layer turn by turn until a defective insulation area is filled; and
S7: fusing the insulation winding tape wound turn by turn into a whole, so as to complete insulation restoration.

14. The method for improving insulation interface performance of a wrapped-type submarine cable molded joint according to claim 5, wherein the unwinding roller, the first constraint roller, the second constraint roller, and the take-up roller are connected to independent drive motors, and the drive motors are mounted on the insulation fixed plate.

15. The method for improving insulation interface performance of a wrapped-type submarine cable molded joint according to claim 14, wherein a constraint on the insulation winding tape is formed by using a first constraint roller in the discharge assembly and a second constraint roller in the receiving assembly, so that the insulation winding tape is kept to move in a set track.

16. The method for improving insulation interface performance of a wrapped-type submarine cable molded joint according to claim 14, further comprising the following steps:
S5: welding a cable conductor, wrapping a conductor shielding layer, and wiping a surface of body insulation;
S6: removing untreated parts of the insulation winding tape at a front end and a back end of the insulation winding tape, and winding the treated insulation winding tape around a surface of the conductor shielding layer turn by turn until a defective insulation area is filled; and
S7: fusing the insulation winding tape wound turn by turn into a whole, so as to complete insulation restoration.
